(19) United States
(12) Patent Application Publication
(10) Pub. No.: US 2006/0004732 A1
(43) Pub. Date: Jan. 5, 2006

(54) Search engine methods and systems for generating relevant search results and advertisements

(76) Inventor: Paul S. Odom, Houston, TX (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/194,766

(22) Filed: Aug. 2, 2005

Related U.S. Application Data
(63) Continuation-in-part of application No. 10/086,026, filed on Feb. 26, 2002.
(60) Provisional application No. 60/592,404, filed on Aug. 2, 2004.

(51) Int. Cl. G06F 17/30

(52) U.S. Cl. 707/3

(57) ABSTRACT

The present invention provides search engine methods and systems for generating relevant search results and displaying relevant advertisements with those search results. The invention provides methods and systems for modeling and storing data in neutral forms, and then applying topification techniques to the data to generate search results that are relevant to a particular user's search request. The invention also applies topification and relevancy methods to associate ads that are relevant to a user with the search results for display.

### CROSS REFERENCE TO RELATED APPLICATIONS

The present application is a continuation-in-part of U.S. patent application Ser. No. 10/086,026, entitled Topic Identification and Use Thereof in Information Retrieval Systems, filed on Feb. 26, 2002 by Paul S. Odom et. al., which is hereby expressly incorporated by reference herein in its entirety.

The present application also claims priority to U.S. Provisional Patent Application No. 60/592,404, entitled Search Engine Methods and Systems for Generating Relevant Results, filed on Aug. 2, 2004 by Paul S. Odom, which is hereby expressly incorporated by reference in its entirety.

### BACKGROUND OF THE INVENTION

1. Field of the Invention

The present invention relates to search engines, and more particularly, to search engine methods and systems that provide relevant advertisements associated with search results.

2. Background of Invention

The world economic order is shifting from one based on manufacturing to one based on the generation, organization and use of information. To successfully manage this transition, organizations must collect and classify vast amounts of data so that it may be searched and retrieved in a meaningful manner. Traditional techniques to classify data may be divided into four approaches: (1) manual; (2) unsupervised learning; (3) supervised learning; and (4) hybrid approaches.

Manual classification relies on individuals reviewing and indexing data against a predetermined list of categories. For example, the National Library of Medicine's MEDLINE® (Medical Literature, Analysis, and Retrieval System Online) database of journal articles uses this approach. While manual approaches benefit from the ability of humans to determine what concepts a data represents, they also suffer from the drawbacks of high cost, human error and relatively low rate of processing. Unsupervised classification techniques rely on computer software to examine the content of data to make initial judgments as to what classification data belongs to. Many unsupervised classification technologies rely on Bayesian clustering algorithms. While reducing the cost of analyzing large data collections, unsupervised learning techniques often return classifications that have no obvious basis on the underlying business or technical aspects of the data.

This disconnect between the data's business or technical framework and the derived classifications make it difficult for users to effectively query the resulting classifications. Supervised classification techniques attempt to overcome this drawback by relying on individuals to “train” the classification engines so that derived classifications more closely reflect what a human would produce.

Illustrative supervised classification technologies include semantic networks and neural networks. While supervised systems generally derive classifications more attuned to what a human would generate, they often require substantial training and tuning by expert operators and, in addition, often rely for their results on data that is more consistent or homogeneous that is often possible to obtain in practice. Hybrid systems attempt to fuse the benefits of manual classification methods with the speed and processing capabilities employed by unsupervised and supervised systems. In known hybrid systems, human operators are used to derive “rules of thumb” which drive the underlying classification engines.

No known data classification approach provides a fast, low-cost and substantially automated means to classify large amounts of data that is consistent with the semantic content of the data itself. Thus, it would be beneficial to provide a mechanism to determine a collection of topics that are explicitly related to both the domain of interest and the data corpus analyzed. Commonly owned, co-pending U.S. patent application, Ser. No. 10/086,026, entitled Topic Identification and Use Thereof in Information Retrieval Systems, filed on Feb. 26, 2002 by Paul Odom, provides such a mechanism.

At the same time, the emergence of the Information Age has created a wealth of information that is available electronically. Unfortunately, much of this information is often inaccessible to individuals because they do not know where to look for it, or if they do know where to look the information can not be found efficiently. For example, an individual is working at his desk and his boss requests that he find an electronic copy of a memo that the individual sent last month. The memo contains information that was obtained from a website, which included a spreadsheet that had data extracted from a division report.

The boss would like the individual to send a copy of the email and the references back to him as soon as possible. Also, he would like the individual to check for additional references to see if the conclusions in the memo need to be updated. The boss requires that the project be completed within fifteen minutes. The worker is not disorganized, but as is common, does not have total recall of how the information was gathered or where the email is stored. After thirty minutes, the worker finally finds the email. But, the worker still needs to search for additional information as requested by his boss. The end result is that because no efficient search mechanism existed the worker has missed his boss' deadline.

The above example commonly occurs within the workplace, and involves not just email, but all forms of electronically stored information. Human worker studies show that it is not unusual for some office workers to spend more than 10% of each work day looking for information. The same studies claim that less than half those searches are successful. Databases, data warehouses, document management systems, and file searches are often too difficult or “hit and miss” to be used effectively and efficiently. Corporate enterprises and government organizations have spent billions of dollars to aggregate and integrate information, so it will be more accessible. Of course, an individual can get answers if he is a database or document system expert and if the individual remembers the exact title, the exact phrasing used in the document, or the ever elusive primary key associated with the document of interest. Unfortunately, more common than not, this level of detail is not available to assist in finding the information.

Internet based searches are often times even more frustrating, and less productive. For example, it is not particularly useful when you know that there are approximately 6,120,000 answers to the search criteria you just entered. Ads associated with search engines are also often frustratingly irrelevant to a search and therefore of little interest to the users and of minimal value to the advertiser. The search engine ads try to identify promising content to be associated with. Unfortunately, these are often not very relevant either. For example, you entered “plasma injectors” and you get several ads for plasma televisions. Individuals have learned that keyword ads are not usually very useful, so individuals often completely ignore keyword ads.

Furthermore, because website popularity has nothing to do with what might be relevant in the thousands of search results, search results driven by website popularity can often lead to useless results. Meanwhile, at search engine operations facility there is an army of personnel and massive server farms humming away to potentially deliver hundreds of thousands of results to every search query that an individual enters.

Web searching, search advertising, and enterprise searching are not consistently providing acceptable search resolution for the user. The missing ingredient in current search technology is “true relevance”. Relevance can only be defined by the user for a specific search. Relevancy has no predictable pattern. No generalized algorithm is going to repeatably produce relevant information, because in the end, any generalization is arbitrary.

What has occurred, so far in the industry, is a fragmentation of search applications as vendors try to address niche search markets in an attempt to improve relevancy by narrowing the domain. For example, sites that are product specific, area-of-interest specific, group specific, or subject specific, have all been implemented. So far, there have been no successful generalized search applications that consistently provide high levels of relevancy.

What are needed are search methods and systems that can efficiently generate search results that are relevant to the particular user's interest and also display advertisements that are relevant to a particular user's interest that accompany the search results.

### SUMMARY OF THE INVENTION

The present invention provides search engine methods and systems for generating relevant search results and displaying relevant advertisements with those search results. The invention provides methods and systems for modeling and storing data in neutral forms, and then applying topification techniques to the data to generate search results that are relevant to a particular user's search request. The invention also applies topification and relevancy methods to associate ads that are relevant to a user with the search results for display.

The systems and methods also analyze the user's inputs using an extensive natural language processing (NLP) scheme and artificial intelligence algorithms. As a result the system is capable of distinguishing contexts, generating highly relevant results, and relevancy ranking of results is customizable. In an embodiment, an interactive drill down with a user during searching inquiries produces a semantic topic network and allows the user to do real time personalization of the semantics.

The present invention can be used to search for information in a plethora of environments, including enterprise systems and across the Internet. The present invention provides for pinpoint search-based advertising, improves search efficiency and provides a flexible search engine system.

Further embodiments, features, and advantages of the invention, as well as the structure and operation of the various embodiments of the invention are described in detail below with reference to accompanying drawings.

### BRIEF DESCRIPTION OF THE FIGURES

The present invention is described with reference to the accompanying drawings. In the drawings, like reference numbers indicate identical or functionally similar elements. The drawing in which an element first appears is indicated by the left-most digit in the corresponding reference number.

FIG. 1 shows, in flowchart form, a method to identify topics in a corpus of data in accordance with one embodiment of the invention.

FIG. 2 shows, in flowchart form, a method to generate a domain specific word list in accordance with one embodiment of the invention.

FIG. 3 shows, in flowchart form, a method to identify topics in a corpus of data in accordance with one embodiment of the invention.

FIG. 4 shows, in flowchart form, a method to measure actual usage of significant words in a corpus of data in accordance with one embodiment of the invention.

FIG. 5 shows, in flowchart form, a topic refinement process in accordance with one embodiment of the invention.

FIG. 6 shows, in flowchart form, a topic identification method in accordance with one embodiment of the invention.

FIG. 7 shows, in flowchart form, one method in accordance with the invention to identify those topics for display during a user query operation.

FIG. 8 shows, in block diagram form, a system in accordance with one embodiment of the invention.

FIG. 9 is a diagram that shows enterprise information sources.

FIG. 10 is a semantic construct table, according to an embodiment of the invention.

FIG. 11 is a topification table, according to an embodiment of the invention.

FIG. 12 is a diagram of a topic hierarchy, according to an embodiment of the invention.

FIG. 13 is a flowchart of a method for displaying advertisements based on search results of data items within a set of information, according to an embodiment of the invention.

FIG. 14 is a flowchart of a method for displaying advertisements based on search results of data items within a set of information using the relevancy of search results, according to an embodiment of the invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Topification

Techniques (methods and devices) to generate domain specific topics for a corpus of data are described. Other techniques (methods and devices) to associate the generated topics with individual documents, or portions thereof, for use in electronic search actions are also described. The following embodiments of the inventive techniques are illustrative only and are not to be considered limiting in any respect.

In one embodiment of the invention, a collection of topics is determined for a first corpus of data, wherein the topics are domain specific, based on a statistical analysis of the first data, corpus and substantially automatically generated. In another embodiment of the invention, the topics may be associated with each “segment” of a second corpus of data, wherein a segment is a uer-defined quantum of information. Example segments include, but are not limited to, sentences, paragraphs, headings (e.g., chapter headings, titles of manuscripts, titles of brochures and the like), chapters and complete documents. Data comprising the data corpus may be unstructured (e.g., text) or structured (e.g., spreadsheets and database tables). In yet another embodiment of the invention, topics may be used during user query operations to return a result set based on a user's query input.

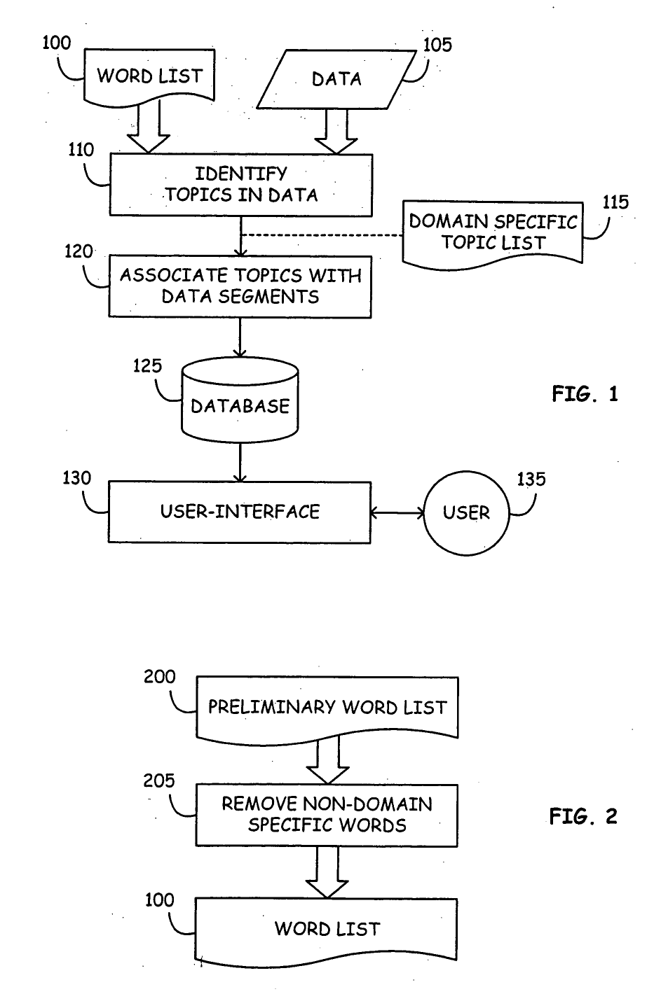

Referring to FIG. 1, one method in accordance with the invention uses domain specific word list 100 as a starling point from which to analyze data 105 (block 110) to generate domain specific topic list 115. Once generated, topic list 115 entries may be associated with each segment of data 105 (block 120) and stored in database 125 where it may be queried by user 135 through user interface 130. Word list 100 may comprise a list of words or word combinations that are meaningful to the domain from which data 105 is drawn. For example, if data 105 represents medical documents then word list 100 may be those words that are meaningful to the medical field or those subfields within the field of medicine relevant to data 105. Similarly if data 105 is drawn from the accounting, corporate governance of the oil processing and refining business, word list 100 will comprise words that hold particular importance to those fields. Data 105 may be substantially any form of data, structured or unstructured. In one embodiment, data 105 comprises unstructured text files such as medical abstracts and/or articles, In another embodiment, data 105 comprises books, newspapers, magazine content or a combination of these sources. In still another embodiment, data 105 comprises structured data such as design documents and spreadsheets describing an oil refinery process. In yet other embodiments, data 105 comprises content tagged image data, video data and/or audio data. lo still another embodiment, data 105 comprises a combination of structured and unstructured data.

Acts in accordance with block 110 use word list 100 entries to statistically analyze data 105 on a segment-by-segment basis. In one embodiment, a segment may be defined as a sentence and/or heading and/or title. In another embodiment, a segment may be defined as a paragraph and/or heading and/or title. In yet another embodiment, a segment may be defined as a chapter and/or heading and/or title. In still another embodiment, a segment may be defined as a complete document and/or heading and/or title. Other definitions may be appropriate for certain types of data and, while different from those enumerated here, would be obvious to one of ordinary skill in the art. For example, headings and titles may be excluded from consideration. It is noted that only a portion of data 105 need be analyzed in accordance with block 110. That is, a first portion of data 105 may be used to generate topic list 115, with the topics so identified being associated with the entire corpus of data during the acts of block 120.

TABLE 1
Example Data

By way of example only, in one embodiment data 105 comprises the text
of approximately 12 million abstracts from the Medline ® data collection.
These abstracts include approximately 2.8 million unique words, repre-
senting approximately 40 Gigabytes of raw data. MEDLINE ® (Medical
Literature, Analysis, and Retrieval System Online) is the U.S. National
Library of Medicine's (NLM) bibliographic database of journal articles
covering basic biomedical research and the clinical sciences including:
nursing, dentistry, veterinary medicine, pharmacy, allied health, pre-
clinical sciences, environmental science, marine biology, plant and animal
science, biophysics and chemistry. The database contains bibliographic
citations and author abstracts from more than 4,600 biomedical journals
published in the United States and 71) other countries. Medline M is
searchable at no cost from the NLM's web site at http://www.nlm.nih.gov.

Referring to FIG. 2, in one embodiment of the invention word list 100 may be generated by first compiling a preliminary list of domain specific words 200 and then pruning front that list those entries that do not significantly and, (r uniquely identify concepts or topics within the target domain (block 205). Preliminary list 200 may, for example, lie comprised of words from a dictionary, thesaurus, glossary, domain specific word list or a combination of these sources. For example, the Internet may be used to obtain preliminary word lists for virtually any field. Words removed in accordance with block 205 may include standard STOP words as illustrated in Table 2. (One of ordinary skill in the art will recognize that other STOP words may be used.) In addition, it may be beneficial to remove words from preliminary word list 200 that are not unique to the larger domain. For example, while the word “reservoir” has a particular meaning in the field of oil and gas development, it is also a word of common use. Accordingly, it may be beneficial to remove this word from a word list specific to the oil and gas domain. In one embodiment, a general domain word list may be created that comprises those words commonly used in English (or another language), including those that are specific to a number of different domains. This “general word list” may be used to prune words from a preliminary domain specific word list. In another embodiment. some common words removed as a result of the general word list pruning just described may be added back into preliminary word list 200 because, while used across a number of domains, have a particular importance in the particular domain.

TABLE 2
Example Stop Words

a, about, affect. after, again, all, along, also, although, among, an, and,
another, any, anything, are, as, at, be, became, because, been, before,
both, but, by, can, difference, each, even, ever, every, everyone, for, from,
great. had, has. have, having, he, hence, here, his, how, however, I, if, in,
inbetween, into, is, it, its, join, keep, last, lastly, let, many, may, me,
more, most, much, next, no, none, not, nothing, now, of, on, only, or,
other, our, pause, quickly, quietly, relationship, relatively, see, she,
should, since, so, some, somebody, someone, something, sometimes,
successful, successfully, such, take, than, that, the, their, there, these, they,
this, those, thus, to, unusual, upon, us, use, usual, view, was, we, went,
what, when, whence, where, whether, ,which, while. who. whose, will,
with, within, without, yes, yet, you, your

TABLE 3
Example Word List

For the data set identified in Table 1, preliminary word list 200 was
derived from the Unified Medical language System Semantic Network (see
http:/www.nlm.nih.gov/datebases/leased.html#umls) and included
4,000,000 unique single-word entries. Of these, roughly 3,945,000 were
moved in accordance with block 205. Accordingly, word list 100 com-
prised approximately 55,000 one word entries. Example word list 200
entries for the medical domain include: abdomen, biotherapy, chlorided,
distichiasis, enzyme, enzymes, freckle, gustatory, immune, kyphoplasty,
laryngectomy, malabsorption, nebulize,, obstetrics, pancytcpenia, quad-
riparesis, retinae, sideeffect, tonsils, unguium. vennicular, womb,
xerostornia, yersinia, and zygote.

Conceptually, word list 100 provides an initial estimation of domain specific concepts/topics. Analysis in accordance with the invention beneficially expands the semantic breadth of word list 100, however, by identifying word collections (e.g., pairs and triplets) as topics (i.e., topic list 115). Once topics are identified, each segment in data 105 may be associated with those topics (block 120) that exist in that segment. Accordingly, if a corpus of data comprises information from a plurality of domains, analysis in accordance with FIG. 1 may be run multiple times-each time with a different word list 100. (Alternatively, each segment may be analyzed for each domain list before a next segment is analyzed.) In this manner, undifferentiated data (i.e., data not identified as belonging to one or another specific domain) may be automatically analyzed and “indexed” with topics. It is noted that word list 100 may be unique for each target domain but, once developed, may be used against multiple data collections in that field. Thus, it is beneficial to refine the contents of word list 100 for each domain so as to make the list as domain-specific as possible. It has been empirically determined that tightly focused domain-specific word lists yield a more concise collection of topics which, in turn, provide improved search results (see discussion below).

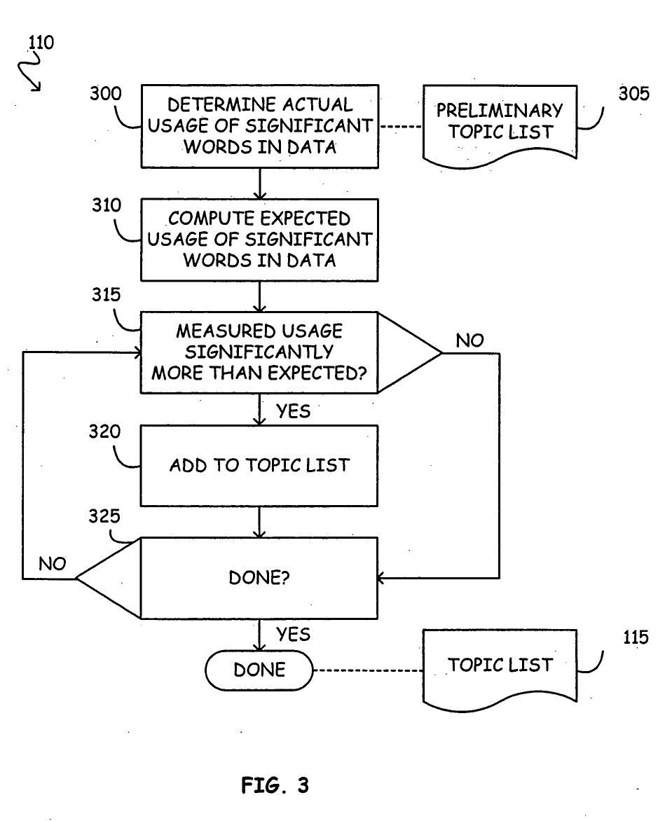

FIG. 3 illustrates one method in accordance with the invention to identify topics (block 110 of FIG. 1) in data 105 using word list 100 as a starting point. Initially, data 105 (or a portion thereof) is analyzed on a segment-by-segment basis to determine the actual usage of significant words and word combinations (block 300). A result of this initial step is preliminary topic fist 305. Next, an expected value for each entry in preliminary topic list 305 is computed (block 310) and compared with the actual usage value determined during block 300 (block 315). If the measured actual usage of a preliminary topic list entry Ls significantly greater than the computed expected value of the entry (the “yes” prong of block 315), that entry is added to topic list 115 (block 320). If the measured actual usage of a preliminary topic list entry Ls not significantly greater than the computed expected value of the entry (the “no” prong of block 315), that entry is not added to topic list 115. The acts of blocks 315 and 320 are repeated (the “no” prong of block 325) until all preliminary topic list 305 entries have been reviewed (the “yes” prong of block 325).

TABLE 4
Example Topic List

For the data set identified in Tables 1 and 3, 10 of the 35 Gigabytes were
used to generate topic list 115. In accordance with FIG. 3, topic list 115
comprised approximately 506,000 entries. In one embodiment, each of
these entries are double word entries.
Illustrative topics identified for Medline (9 abstract content in accordance
with the invention include: adenine nucleotide, heart disease, left
ventricular. atria ventricles, heart failure, muscle, heart rate, fatty acids,
loss bone, patient case, bone marrow, and arterial hypertension.

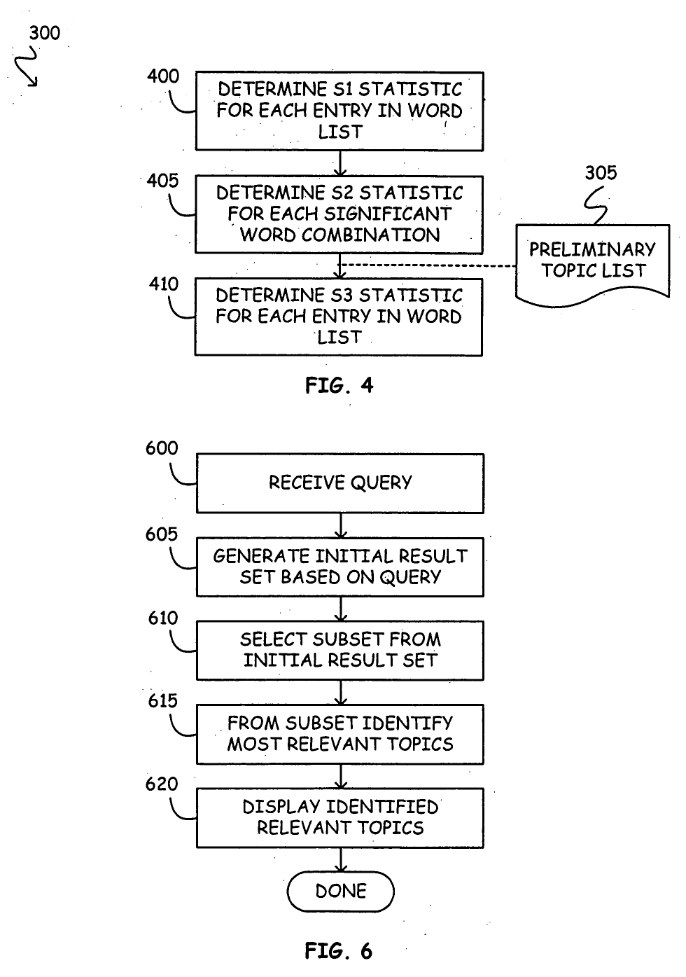

As shown in FIG. 4, one method to measure the actual usage of significant words in data 105 (block 300) is to determine three statistics for each entry in word list 100: S1 (block 400); S2 (block 405); and S3 (block 410). In general, statistics S1, S2 and S3 measure the actual frequency of usage of various words and word combinations in data 105 at the granularity of the user-defined segment. More specifically:

Statistic S1 (block 400) is a segment-level frequency count for each entry in word list 100.

For example, if a segment is defined as a paragraph, then the value of S1 for word-i is the number of unique paragraphs in data 105 in which word-i is found.

An S1 value may also be computed for non-word list 100 words if they are identified as part of a word combination as described below with respect to statistic S2.

Statistic S2 (block 405) is a segment-level frequency count for each significant word combination in data 105. ‘nose word combinations having a non-zero S2 value may be identified as preliminary topics 305. In one embodiment, a “significant word combination” comprises any two entries in word list 100 that are in the same segment. In another embodiment, a “significant word combination” comprises any two entries in word list 100 that are in the same segment and contiguous. In still another embodiment, a “significant word combination” comprises any two entries in word list 100 that are in the same segment and contiguous or separated only by one or more STOP words. In yet another embodiment, a 11 significant word combination” comprises any two words that are in the same segment and contiguous or separated only by one or more STOP words where at least one of the words in the word combination is in word list 100. In general, a “significant word combination” comprises any two or more words that are in the same segment and separated by ‘N’ or fewer specified other words: N may be zero or more; and the specified words are typically STOP words. As a practical matter, word combinations comprising non-word list 100 words may be ignored if they appear in less than a specified number of segments in data 105 (e.g., less than 10 segments).

For example, if a segment is defined as a paragraph, then the value of S2 for word-combination-i is the number of unique paragraphs in data 105 in which word-combination-i is found.

Statistic S3 (block 410) indicates the number of unique word combinations (identified by having non-zero S2 values, for example) each word in word list 100 was found in.

For example, if word-z is only a member of word-combination-i, word-combination-j and word-combination-k and the S2 statistic for each of word-combination-i, word-combination-j and word-combination-k is non-zero, then word-z's S3 value is 3.

One method to compute the expected usage of significant words in data 105 (block 310) is to calculate the expected value for each preliminary topic list 305 entry based only on its overall frequency of use in data 105. In one embodiment, the expected value for each word pair in preliminary word list 305 may be computed as follows:
{S1(word-i)×S1(word-j)}÷N
where S1 (word-i) and S1 (word-j) represents the S1 statistic value for word-i and word-j respectively, and N represents the total number of segments in the data corpus being analyzed. One of ordinary skill in the art will recognize that the equation above may be easily extended to word combinations have more than two words.

Referring again to FIG. 3, with measured and computed usage values it is possible to determine which entries in preliminary topic list 305 are suitable for identifying topics within data 105. In one embodiment, the test (block 315) of whether a topic's measured usage (block 300) is significantly greater than the topic's expected usage (block 310), is a constant multiplier. For example, if the measured usage of preliminary topic list entry-i is twice that of preliminary topic list entry-i is expected usage, preliminary topic list entry-i may be added to topic list 115 in accordance with block 320. In another embodiment of the invention, if the measured usage of preliminary topic list entry-i is greater than a threshold value (e.g., 10) across all segments, then that preliminary topic list entry is selected as a topic. One of ordinary skill in the art will recognize alternative tests may also be used. For example, a different multiplier may be used (e.g., 1.5 or 3). Additionally conventional statistical tests of significance may be used.

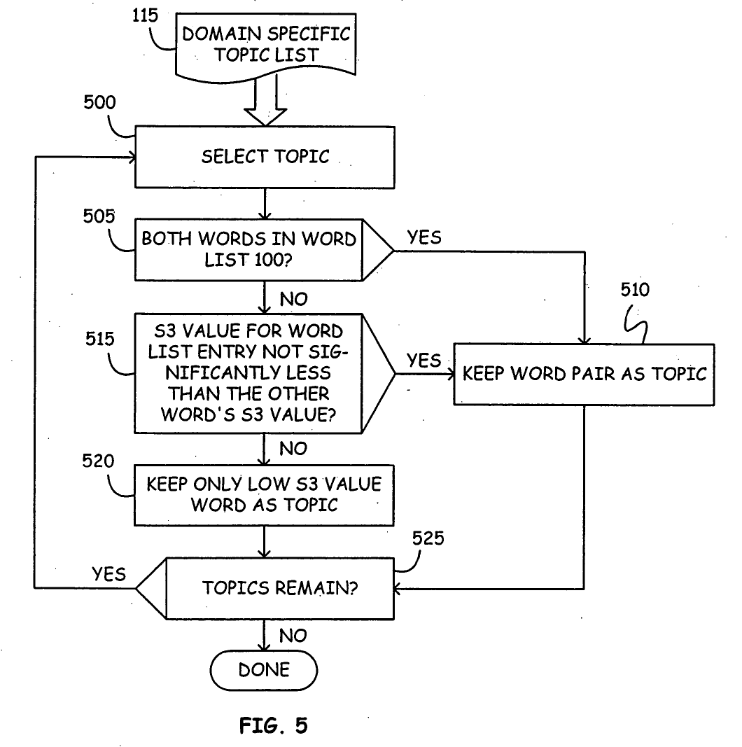

In one embodiment, topic list 115 may be refined in accordance with FIG. 5. (For convenience, this refinement process will be described in terms of two-word topics. One of ordinary skill in the art will recognize that the technique is equally applicable to topics having more than two words.) As shown, a first two word topic is selected (block 500). If both words comprising the topic are found in word list 100 (the “Yes” prong of block 505), the two word topic is retained (block 510). If both words comprising the topic are not found in word list 100 (the “no” prong of block 505), but the S3 value for that word which is in word list 100 is not significantly less than the S3 value for the other word (the yes” prong of block 515), the two word topic is retained (block 510). If, on the other hand, one of the topic's words is not in word list 100 (the “no” prong of block 505) and the S3 value for that word which is in word list 100 is significantly less than the S3 value for the other word (the “no” prong of block 515), only the low S3 value word is retained in topic list 115 as a topic (block 520). The acts of blocks 500-520 are repeated as necessary for each two word topic in topic list 115 (see block 525). In one embodiment, the test for significance (block 515) is based on whether the “high” S3 value is in the upper one-third of all S3 values and the “low” S3 value is in the lower one-third of all S3 values. For example, if the S3 statistic for a corpus of data has a range of zero to 12,000, a low S3 value is less then or equal to 4,000 and a “high” S3 value is greater then or equal to 8,000. In another embodiment, the test for significance in accordance with block 515 may be based on quartiles, quintiles or Bayesian tests. Refinement processes such as that outlined in FIG. 5 acknowledge word associations within data, while ignoring individual words that are so prevalent alone (high S3 value) as to offer substantially no differentiation as to content.

Referring again to FIG. 1, once topic list 115 is established, each segment in data 105 may associated with those topics which exist within it (block 120) and stored in database 125. Topics may be associated with a data segment in any desired fashion. For example, topics found in a segment may be stored as metadata for the segment. In addition, stored topics may be indexed for improved retrieval performance during subsequent lookup operations. Empirical studies show that the large majority of user queries are “under-defined.” That is, the query itself does not identify any particular subject matter with sufficient specificity to allow a search engine to return the user's desired data in a result set (i.e., that collection of results presented to the user) that is acceptably small. A typical user query may be a single word such as, for example, “kidney.” In response to under-defined queries, prior art search techniques generally return large result sets—often containing thousands, or tens of thousands, of “hits.” Such large result sets are almost never useful to a user as they do not have the time to go through every entry to find that one having the information they seek.

In one embodiment, topics associated with data Segments in accordance with the invention may be used to facilitate data retrieval operations as shown in FIG. 6. When a user query is received (block 600) it may be used to generate an initial result set (block 605) in a conventional manner. For example, a literal text search of the query term may identify 100,000 documents (or objects stored in database 125) that contain the search term. From this initial result set, a subset may be selected for analysis in accordance with topics (block 610). In one embodiment, the subset is a randomly chosen 1% of the initial result set. In another embodiment, the subset is a randomly chosen 1,000 entries from the initial result set. In yet another embodiment, a specified number of entries are selected from the initial result set (chosen in any manner desired). While the number of entries in the resu It subset may be chosen in substantially any manner desired, it is preferable to select at least a number that provides “coverage” (in a statistical sense) for the initial result set. In other words, it is desirable that the selected subset mirror the initial result set in terms of topics. With an appropriately chosen result subset, the most relevant topics associated with those results may be identified (block 615) and displayed to the user (block 620).

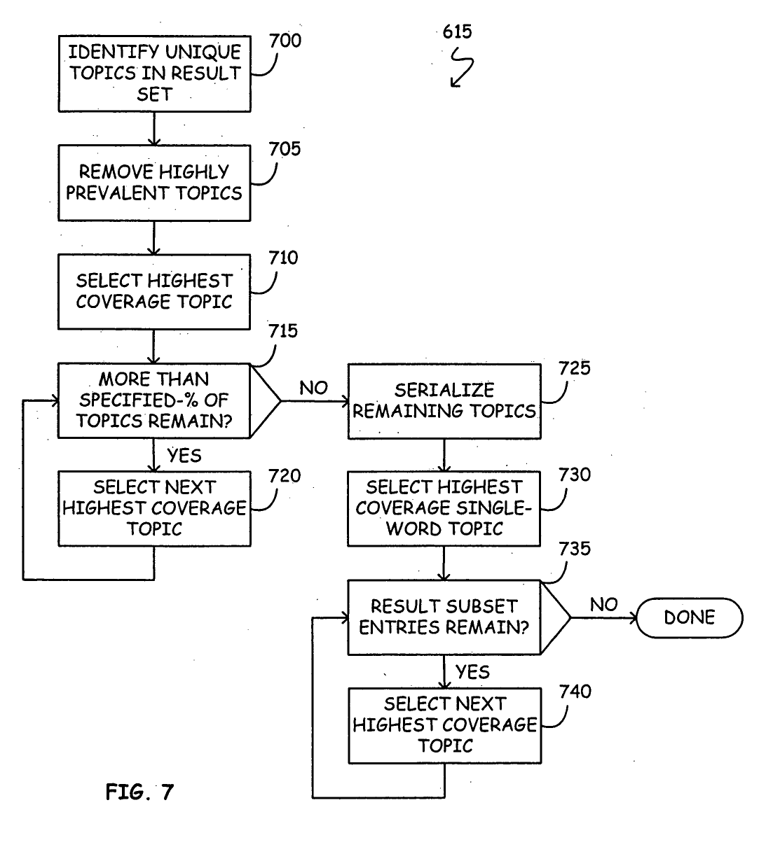

FIG. 7 shows one method in accordance with the invention to identify those topics for display (block 615). Initially, all unique topics associated with the result subset are identified (block 700), and those topics that appear in more than a specified fraction of the result subset are removed (block 705). For example, those topics appearing in 80% or more of the segments comprising the result subset may be ignored for the purposes of this analysis. (A percentage higher or lower than this may be selected without altering the salient characteristics of the process.) Next, that topic which appears in the most result subset entries is selected for display (block 710). If more than one topic ties for having the most coverage, one may be selected for display in any manner desired. If, after ignoring those result subset entries associated with the selected topic, there remains more than a specified fraction of the result subset (the “yes” prong of block 715), that topic having the next highest coverage is selected (block 720). The process of blocks 715 and 720 is repeated until the remaining fraction of result subset entries is at or below the specified threshold. In one embodiment, the specified threshold of block 715 is 20%, although a percentage higher or lower than this may be selected without altering the salient characteristics of the process.

If, after ignoring those result subset entries associated with the selected topic(s), there remains less than a specified fraction of the result subset (the “no” prong of block 715), the remaining topics are serialized and duplicate words are eliminated (block 725). That is, topics comprising two or more words art; broken apart and treated as single-word topics. Next, that single-word topic that appears in the most result subset entries not already excluded is selected for display (block 730). As before, if more than one topic ties for having the most coverage, one may be selected for display in any manner desired. If, after ignoring those result subset entries associated with the selected topic, result subset entries remain un-chosen (the “yes” prong of block 735), that topic having the next highest coverage is selected (block 740). The process of blocks 735 and 740 is repeated until all remaining result subset entries are selected for display (the “no” prong of block 735).

The topics identified in accordance with FIG. 7 may be displayed to the user (block 620 in FIG. 6). Thus, data retrieval operations in accordance with the invention return one or more topics which the user may select to pursue or reline their initial search. Optionally, a specified number of search result entries may be displayed in conjunction with the displayed topics. By selecting one or more of the displayed topics, a user may be presented with those data corresponding to the selected topics. (Topics may, for example, be combined through Boolean “and” and/or “or” operators.) In addition, the user may be presented with another list of topics based on the “new” result set in a manner described above. In summary, search operations in accordance with the invention respond to user queries by presenting a series of likely topics that most closely reflect the subjects that their initial search query relate to. Subsequent selection of a topic by the user, in effect, supplies additional search information which is used to refine the Search.

TABLE 5
Example Query Result

For the data set identified in Tables 1, 3 and 4, a search on the single word
“kidney” returns an initial result set comprising 147,549 hits. (That is,
147,549 segments had the word kidney in them.) Of these, 1,000 were
chosen as i result subset. Using the specified thresholds discussed above,
the following topics were represented in the result set: amino acid,
dependent presence, amino terminal, kidney transplantation, transcriptional
regulation, liver kidney, body weight, rat kidney, filtration fraction, rats
treated, heart kidney, renal transplantation, blood pressure, and renal
function. Selection of the “renal function” topic identified a total of 6,853
entries divided among the following topics: effects renal, kidney trans-
plantation, renal parenchyma, glomerular filtration, loss renal, blood flow,
histological examination, renal artery, creatinine clearance, intensive care,
and renal failure. Selection of the “glomerular filtration” topic from this
list identified a total of 1,400 entries. Thus, in two steps the number of
“hits” through which a person must search was reduced front approxi-
mately 148,000 to 1,500-a reduction of nearly two orders of magnitude.

It is noted that retrieval operations in accordance with FIG. 6 may not be needed for all queries. For example, if a user query includes multiple search words or a quoted phrase that, using literal text-based search techniques, returns a relatively small result set (e.g., 50 hits or fewer), the presentation of this relatively small result set may be made immediately without resort to the topic-based approach of FIG. 6. What size of initial result set that triggers use of a topic-based retrieval operation in accordance with the invention is a matter of design choice. In one embodiment, all initial result sets having more than 50 hits use a method in accordance with FIG. 6. In another embodiment, only initial result sets having more than 200 results trigger use of a method in accordance with FIG. 6.

One of ordinary skill in the art will recognize that various changes in the details of the illustrated operational methods are possible without departing from the scope of the claims. For example, various acts may be performed in a different order from that shown in FIGS. 1 through 7. In addition, usage statistics other than those disclosed herein may be employed to measure a word's (or a word combination's) actual usage in a targeted corpus of data. Further, query result display methods in accordance with FIGS. 6 and 7 may use selection thresholds other than those disclosed herein.

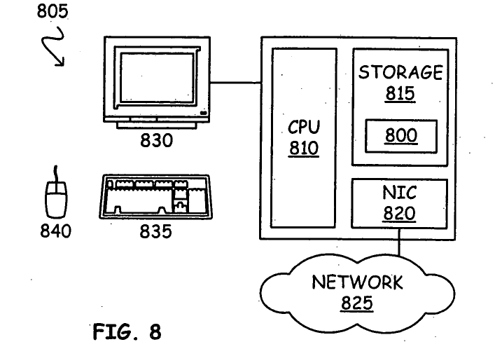

Referring to FIG. 8, acts in accordance with any, or a portion of any, of FIGS. 1 through 7 may be performed by a programmable control device executing instructions organized into one or more program modules 800. In one embodiment, programmable control device comprises computer system 805 that includes central processing unit 810, storage 815, network interface card 820 for coupling computer system 805 to network 825, display unit 830, keyboard 835 and mouse 840. In addition to a single processor system shown in FIG. 8, a programmable control device may be a multiprocessor computer system or a custom designed state machine. Custom designed state machines may be embodied in a hardware device such as a printed circuit board comprising, discrete logic, integrated circuits, or specially designed Application Specific Integrated Circuits (ASICs). Storage devices, such as device 815, suitable for tangibly embodying program module(s) 800 include all forms of non-volatile memory including, but not limited to: semiconductor memory devices such as Electrically Programmable Read Only Memory (EPROM), Electrically Erasable Programmable Read Only Memory (EEPROM), and flash devices; magnetic disks (fixed, floppy, and removable); other magnetic media such as tape; and optical media such as CD-ROM disks.

Generation of Relevant Search Results and Advertisements

The present invention using sophisticated natural language processing and interactive artificial intelligence (AI) algorithms based on automated classification, can generate search results that are highly relevant, referred to as “true relevance” to a user's search request. The present invention can provide true relevance within search results for both an end user and an advertiser.

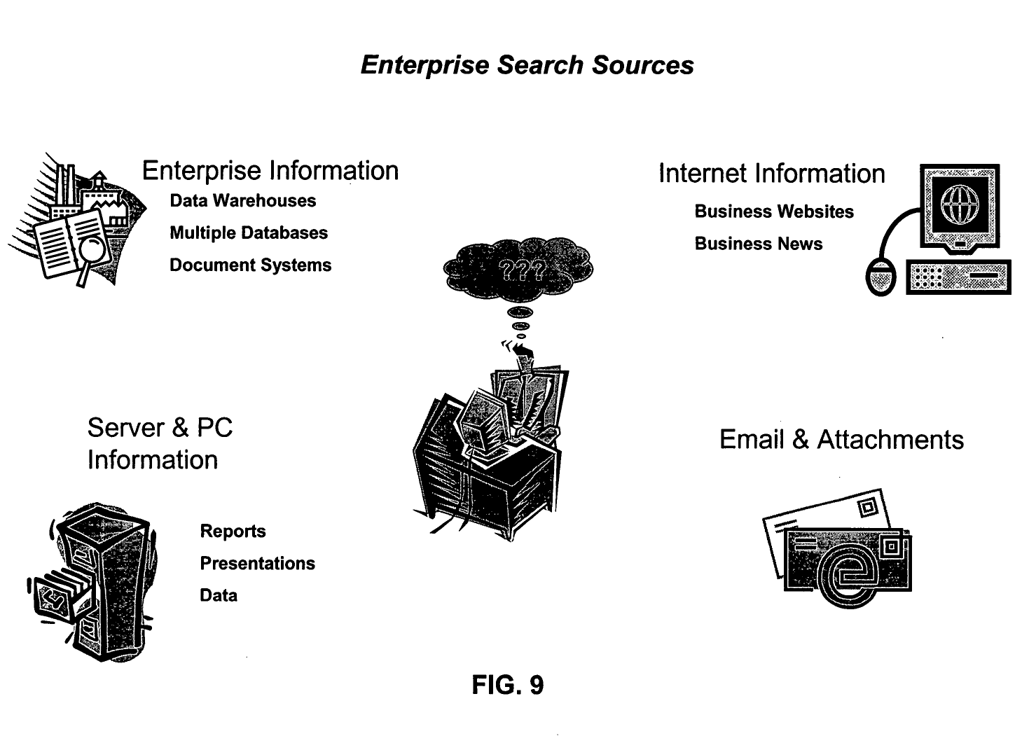

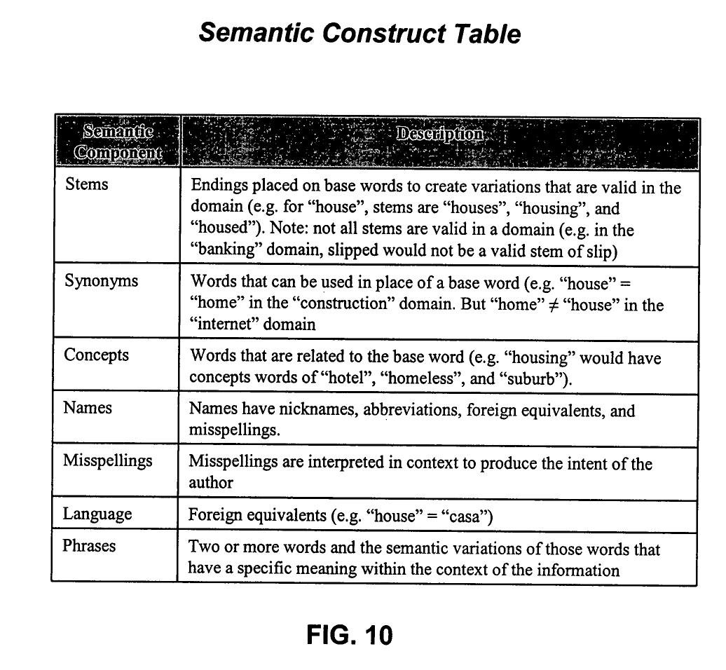

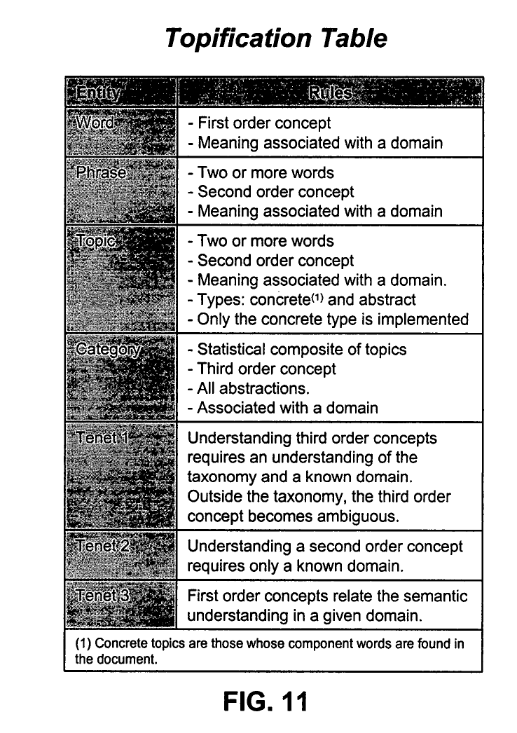

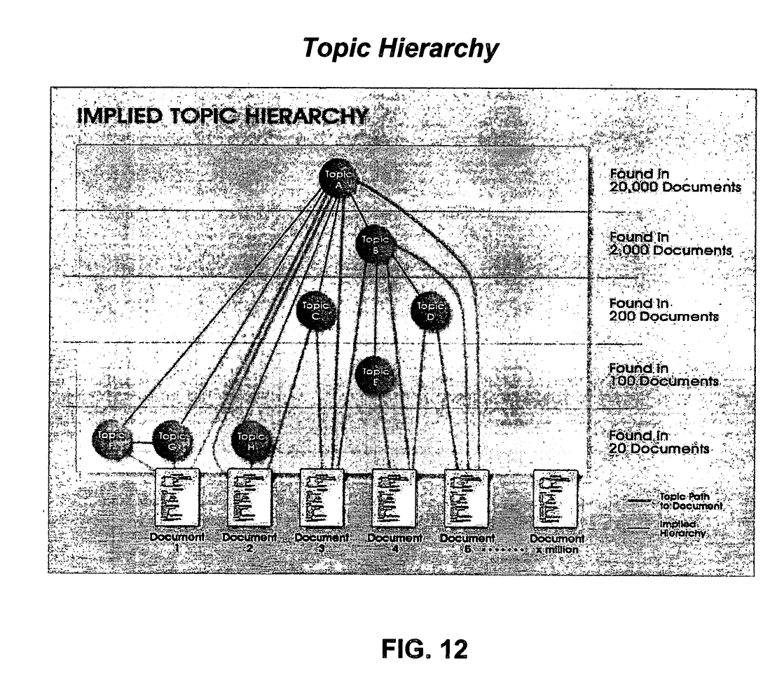

FIG. 9 provides a diagram that shows enterprise information sources. An office worker seated as his desk in front of the computer with a need to find information has a dilemma. The diagram illustrates that there are at least four main sources of information: enterprise information, server and PC information, Internet information, and email and attachments. Enterprise information can include data warehouses, multiple databases, and document systems. Server and PC information can include reports, presentations and data generated by the worker or his colleagues. Internet information can include a wealth of information, including business websites and business news. These are a few examples of the types of information that can be searched using the present invention, and are not intended to limit the scope of the invention.

The dilemma facing the office worker is where is the information? Can the information be found locally in a file? Is it on the departnent's server, in a file, in an email, or in an attachment to an email? Is it in a corporate database or warehouse or in a document management system? Or finally, is it on the web?

Information within the enterprise is doubling every five years and doubling every 6 years on the web. And that is not counting the scores of duplicate emails, attachments, and corporate documents. More and more time is being spent trying to find information and less of all the relevant information is being found. So, productivity is negatively affected. The quality of the decisions is poorer because of incomplete information and the risk of negative economic impacts rise.

The first step in addressing the information dilemma is to provide real-time aggregation of information where the context (e.g. title, to, from, name, product, etc.) is identified and maintained. This must be done without requiring normalization of the data. Or, in other words, the information must be imported “as is” without having to reformat or transform the information into some common form. Examples of methods for aggregating the data are taught in commonly owned U.S. Pat. No. 5,842,213, entitled Method for Modeling, Storing and Transferring Data in Neutral Form, issued Nov. 24, 1998 to Odom et al., and U.S. Pat. No. 6,393,426, also entitled Method for Modeling, Storing and Transferring Data in Neutral Form, issued May 21, 2002 to Odom et al., which are herein incorporated by reference in their entireties. These are provided as example methods of modeling and storing data, and are not intended to limit the scope of the present invention.

The proposed aggregation addresses the issue of practically pooling diverse information. The second step relates to the search problem, or put another way, finding the needed information—the proverbial needle in the haystack.

True relevancy is the missing ingredient in search. The industry is looking for ways to produce better results for the user. This is particularly true when the user is searching for specific content as opposed to general information from an omnibus website. The emphasis is on trying to find a way to easily determine which information is relevant to the user.

One part of understanding which information is relevant to the user is by trying to understand the intent of what the user enters for the search. More sophisticated natural language processing (NLP) is required to achieve “intent-based” search. The other part of determining what is relevant to the searcher is to extract that information directly from the person doing the search—effortlessly if possible. Both of these requirements will be resource intensive with current technologies. Search engine vendors already have massive hardware installations. Imagine what a quadrupling of resource requirements would do to the present cost structures. Not to mention the resource logistics.

The present invention uses sophisticated natural language processing and interactive artificial intelligence (AI) algorithms based on automated classification to provide true relevance in an efficient manner.

As discussed above real-time aggregation of information within a data corpus where the context (e.g. title, to, from, name, product, etc.) is identified and maintained occurs first. The present invention uses a method for handling information termed “Projection Technology.” The present invention atomizes the information into individual words and then creates extremely efficient meta-data. Example methods for aggregating the data are taught in U.S. Pat. No. 5,842,213, issued Nov. 24, 1998 to Odom et al., and U.S. Pat. No. 6,393,426 issued May 21, 2002 to Odom et al.

Applying this technology to the search problem has created the ability to process information in a number of unique ways to accomplish real-time updates to the production environment, classification, and natural language processing.

The present invention supports zero latency. When new information is added there is no re-indexing required. Because the meta data is so extensive, the addition of new information becomes only a simple adjustment to the meta data.

The present invention also supports full automation. Automated crawling of the target information is common in the industry, but implementation of NLP and taxonomy classification has been a manual or training process. The present invention has fully automated implementations of crawling, NLP, classification, and loading. In the system the automated implementation of semantics is accomplished by using existing thesaurus data sets which are accessed in a single query to evaluate all the possible variations. This often involves 20 or more variations for each word the user enters into the search query. Semantics data coupled with the identification of phrases form the NLP methodology used in the present invention. An example method is disclosed in commonly owned pending U.S. patent application Ser. No. 10/086,026, filed Feb. 26, 2002. The automated methodology disclosed has been developed to extract subject descriptions from the content. This methodology can be referred to as “Topification.”

Natural Language Programming

The present invention has an automated procedure for the definition of semantics. Additionally, the application interface can provide the user with the capability to personalize semantics in real-time. The handling of the semantics in the query process has been integrated into a search engine. This provides superior performance and allows the semantics to be independent (orthogonal to) of the data. With this implementation it is possible to do many semantic variations without the performance constraints.

FIG. 2 provides a semantic construct table, according to an embodiment of the invention. The construct table can be used to explain the scope of the present invention's implementation. The table shows and explains semantic constructs for stems, synonyms, concepts, names, misspellings, language and phrases.

Topiflcation

Taxonomies were developed by a biologist in the 1800's to classify plants and animals. Plants and animals are real entities: a rabbit vs. a cow or a rose vs. a sunflower. These are groups of objects that are easily understood and identified by the concrete differences in their attributes. Taxonomies have been adapted for use in classifying information. Categories of subject matter replace what in the original methodology were entities (i.e. plants and animals). Documents have differences, but these differences can often be abstract and/or very subtle. This usually means the differences are qualitative and require significant manual effort to create and maintain.

Topification is a solution to the classification problem in electronic information. Topification uses topics to categorize documents and document content. FIG. 3 provides a topification table that provides definitions, concepts, rules and tenets (collectively known as an ontology), according to an embodiment of the invention. The topification table shows that understanding topics (second order concepts) is much easier than understanding categories (third order concepts). This is validated when manual effort, training exercises, or example Meta data sets are used to “define” the “meaning” of the category

Defining a third order concept (an abstraction) requires significant knowledge and understanding. Topics, however, only require knowledge of their domain to be understood. Since topics are concrete (not abstract), knowledge workers recognize their meaning with respect to the area of interest.

Topics form a network that has an implied hierarchy. FIG. 4 shows a hierarchy that illustrates the relationship between a hypothetical set of topics and documents, according to an embodiment of the invention. Any given document contains a set of topics. In the hierarchy, solid lines represent paths from topics to the documents they are contained in. For example, Topic A is found in Documents 1, 2, 3 and 5 (as well as an approximate 20,000 additional documents). Topic B is found in Documents 3, 4 and 5 (as well as an approximate 2,000 additional documents).

The diagram's bands indicate the (relative) number of documents that contain a given topic. So, Topic A at the top of the diagram is contained in more documents than any other topic. Topic B is found in fewer documents than Topic A, but in more documents than Topics C, D, E, F, G, or H. The implied hierarchy is a result of the frequency that a topic occurs in the document set. A topic that appears in many documents is less specific and, therefore, higher in the hierarchy than a topic that appears in just a few documents.

Topic A is related to any topic that occurs with it in a document. For example, Topic A and C both are found in Document 2. Topic A is found in more documents than Topic C, so Topic A is an implied parent of Topic C as expressed by the line connecting both.

Topification uses this topic hierarchy network approach to navigate and display search results. Topic networking characteristics become apparent when studying paths to Document 4. Topic A is not found in Document 4, but both Topic B and Topic D are found in other documents with Topic A. If Topic A is selected as a search constraint, then Topics B, C, D, E, F, G, and H are viable topic results since they are found in common documents along with Topic A. Notice that even though Document 4 does not contain Topic A, it is on a path from Topic B or Topic D. So picking Topic B and then Topic D would lead to the display of Document 4 as a relevant search result.

Topic D has two implied parents: Topics A and B. This means coverage in the topic selection process is extensive because there are multiple paths to relevant results. Taxonomies do not have this networking property. There is only one parent for each child in taxonomy.

Topification coupled with natural language processing produces a multi-path semantic network to the searcher's desired result. In contrast, taxonomy has one and only one path to a set of results which may or may not include all the relevant documents.

Now that the principle of topification is understood, let's take a look at the practical implementation of this principle at scale. The largest enterprise taxonomy is around 40,000 hierarchical categories. Let's say you have 40 million documents in your information pool. Then on average each category would contain roughly 1000 entries. These 1000 entries represent the granularity of the classification technique applied to this information. A thousand documents are a lot for the user to shift through, so the user has the burden of coming up with additional search constraint words to reduce the result set. Or the system must provide the user's most relevant results at the top of the list.

In contrast, to defined taxonomies, the present invention can handle millions of topics. Using our previous example lets assume that the present invention has defined 4 million topics. Then on average each topic will provide a granularity of 10 documents. In practice there is a range which is typically less than 100. With a single distinct search word entered by the user it is not unusual to produce a set of results that are less than 20.

Interactive Determination of Relevance

The system uses artificial intelligence (AI) to evaluate the query entries made by the user to develop a list of topics that will provide paths to all of the potential solutions sets. As the searcher picks additional topics or adds additional constraint words to the search, the AI routines re-evaluate the constraints to provide a new list of topics. In this interactive process the system is evaluating all the potential solutions to the user's constraints and provides to the user knowledge of what is relevant to the current search. The searcher in turn, by clicking on relevant topics is providing the system information about what is relevant and what is not. It is typical to take only 3 or 4 clicks to arrive at a handful of relevant results. True Relevance in the sense that through the interaction the user has defined what is relevant for the search at hand. The AI routines only work effectively if they are integrated with the semantics (stems, synonyms, phrases, etc.) and reasonable granularity.

Pinpoint Advertising

When the user is interested in what the marketer has to offer, then that is the time that the ad needs to appear to the user. The user doesn't want the distraction of irrelevant ads. In a sense it becomes negative conditioning—ignore the ads because they aren't useful. If the advertisements that appear are consistently on target with respect to the searcher's interest, then those ads become another resource in the user's search effort. The probability of a profitable visit increases dramatically for both the user and advertiser. Paid inclusion ads that are highly relevant would no longer have a negative effect on the apparent search performance. In short, put the right ad in front of the searcher at the right time and it has the potential to turn into a win-win situation for both user and advertiser.

The present invention provides a way for the user to express the domain of interest. Since relevancy is expressed through a “known” set of topics the marketers can determine the set of topics that apply to their products. Relevancy for a single semantically enabled topic is more than a factor of two greater than for two single words and relevancy increases exponentially with each additional topic added by the user. If a combination of topics and constraint words are used, then advertisements that qualify will be relevant in almost all cases.

The relevancy ranking is customizable. Options for relevancy ranking would include any or all the following, but is not limit to this list:
What components of the document contain that search constraints are more relevant (e.g. title, first paragraph, first page, author, etc.)
Proximity of search text
The popularity of the site
The level of semantics that had to be applied to the result (e.g. literal is more relevant than stems than synonyms than concepts)
Previous click throughs

This appropriate relevancy ranking can significantly reduce the resource requirements if the user uses more relevant results as a basis for refining the search.

Using the present invention, marketers can have significant improvements in search based-advertising. With the present invention, the user can express the domain of interest, relevancy is defined by combinations of millions of topics, relevancy for a single topic is at least twice that of for two single words and relevancy increases exponentially with each additional topic added by a user.

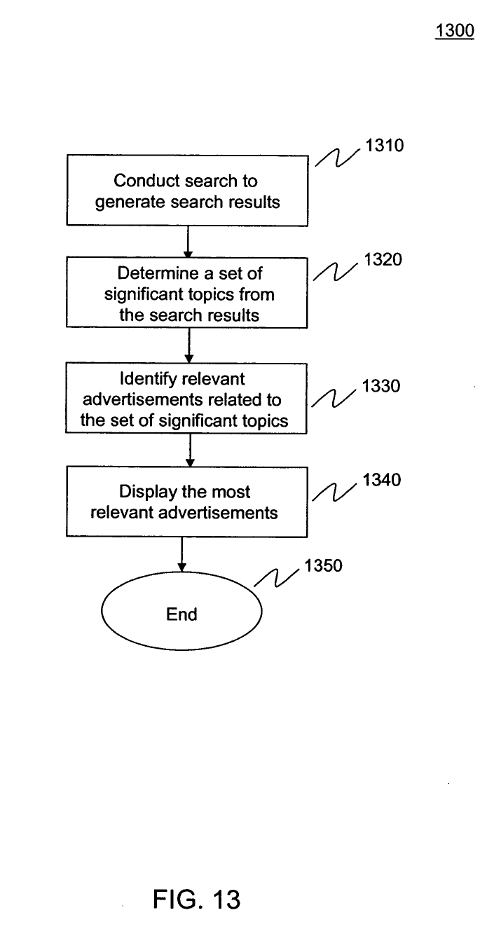

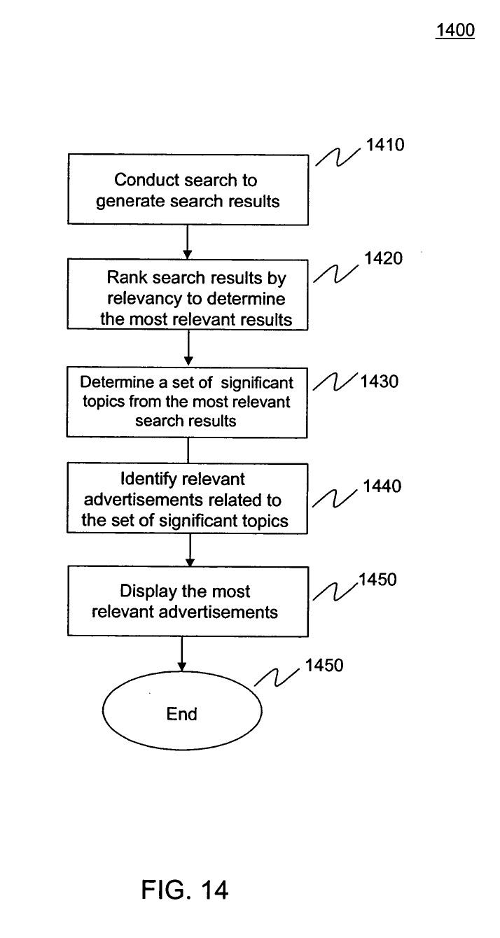

FIG. 13 provides method 1300 for displaying advertisements based on search results of data items within a set of information when a user enters a search constraint, in accordance with an embodiment of the invention. Methods 1300 and 1400 presented in FIG. 14 provides example implementations for displaying relevant advertisements with search results based on the above methods and concepts disclosed for topification and pinpoint advertisements.

Method 1300 begins in step 1310. In step 1310 a search to generate the search results is conducted within a set of information. The search results include a set of data items contained within the set of information. The set of information can include, but is not limited to one or more of information located within an enterprise network, information located within a server, information located within a personal computer, information located on the Internet, or information contained within email messages or email attachments. The data items can include, but are not limited to one or more of text documents, graphic documents, audio files, video files, multimedia documents, email messages, email attachments, or Internet web page.

In one embodiment, the search includes identifying topics in a data corpus having a plurality of segments that is representative of the set of information. Identifying topics includes determining a segment-level actual usage value for one or more word combinations, computing a segment-level expected usage value for each of the one or more word combinations, and designating a word combination as a topic if the segment-level actual usage value of the word combination is substantially greater than the segment-level expected usage value of the word combination.

The search then associates topics with each data item included within the set of information. In embodiment the association of topics with each data item can be completed prior to conducting a search. Finally, the search can determine that a data item should be included in the search results, when a topic entered by the user matches or is similar to a topic associated with the data item. A topic entered by a user matches a topic associated with the data item when the topics are the same, for example the user enters “spear fishing” and the topic is “spear fishing.” A topic is similar to the term or phrase entered by the user when the topics are the same except for minor spelling errors or capitalization. The topic can also be similar to the user constraint when the terms are semantically similar. For example, “fishing spear” would be semantically similar to “spear fishing.” The topic can also be similar to the user constraint when a portion of the user constraint matches a portion of the topic, for example, one word in the topic matches one word in the user constraint.

In step 1320 a set of significant topics from the search results is determined. A topic can include one or more words for this purpose. However, when topics include two or more words the effectiveness of the search is significantly improved. In this case a topic includes a word combination of two or more substantially contiguous words. The two or more words can be considered substantially contiguous if they are separated only by zero or more words selected from a predetermined list of words. In one embodiment the predetermined list of words comprises STOP words. In another approach, at least one word in each of the word combinations making up the topics is selected from a predetermined list of words in which the predetermined list of words includes a list of domain specific words. For example, a predetermined list of words associated with the domain of baseball, might include bat, glove, baseball, etc.

In one embodiment, determining a set of significant topics includes first counting the frequency of occurrence of each topic within the search results. So, for example, if the topic was “spear fishing” and there were 100 data items in the search results. A count would be made of all the occurrences of “spear fishing” in the 100 data items. Once a count was completed for each topic, the topics are hierarchically ranked based on the frequency of occurrence of the topic. So, for example, the topic occurring most frequently would be ranked 1, the topic occurring second most frequently would be ranked 2, and so on.

A topic is then identified as among the set of significant topics when its frequency of occurrence ranks above a significant topic threshold. The significant topic threshold is the number of topics to be included in the set of significant topics. In one embodiment, the significant topic threshold is ten. The significant topic threshold can be adjusted based on the particular needs and factors associated with a search.

In another embodiment, determining the set of significant topics from the search results includes for each topic determining a data item count. The topic data item count is the number of data items within the search results that the topic appears in. Rather than counting the total frequency of occurrences of a topic, as in the previous embodiment, only the number of data items that a topic occurs in is counted. Thus, whether a topic occurred ten times or only once in a particular data item, the data item count would be one.

Once a data item count is determined, the topics are hierarchically ranked based on the data item count of the topic. For example, a topic within the highest data item count is given a ranking of 1, the topic with the second highest data item count is given a ranking of 2, and so on.

A topic is then identified to be included among the set of significant topics when it ranks above the significant topic threshold. The significant topic threshold is the number of topics to be included in the set of significant topics.

In yet another embodiment for determining the set of significant topics, the most specific topics are included in the set of significant topics. In this case a preliminary set of most significant topics from the search results are determined. Note that either approach of using the frequency of occurrence or data item count can be used to determine the preliminary set of most significant topics and also to identify which topics are most specific.

For each topic in the preliminary set of most significant topics, the topic's frequency of occurrence (or data item count, depending on the approach) within the set of information is determined. Next, the most specific topics within the preliminary set of most significant topics are determined as those that have the lowest frequency of occurrence within the set of documents. For example, the topic within the lowest frequency of occurrence within the set of information is given a ranking of 1, the topic with the second lowest frequency of occurrence within the set of information is given a ranking of 2, and so on.

This appears counterintuitive. However, if a topic is considered significant, but does not occur in many of the other data items within the overall set of information, this suggests that it is uniquely important to the data items in the search results rather than simply being very common in all data items in the set of information. Therefore, the topic is likely to be of more significance to the user.

A topic is identified as among the most specific topics when its frequency of occurrence ranks above the specific topic threshold. The specific topic threshold is the number of topics to be included in the most specific topics.

Referring back to FIG. 13, in step 1330 relevant advertisements related to the set of significant topics are identified. In one embodiment, relevant advertisements that are related to the set of significant topics includes selecting an advertisement as relevant when a topic associated with the advertisement matches one of the topics within the set of significant topics.

Alternatively, relevant advertisements that are related to the set of significant topic includes selecting an advertisement as relevant when a topic associated with the advertisement matches the top ranked topic within the set of significant topics.

In another alternative approach, relevant advertisements that are related to the set of significant topic includes selecting an advertisement as relevant when a topic associated with the advertisement is similar to a topic within the set of significant topics.

A topic associated with an advertisement matches one of the topics within the set of significant topics if the topics are the same. For example the topic associated with an advertisement is “spear fishing” and a topic within the set of significant topics is “spear fishing.” Topics are similar when the topics are the same except for minor spelling errors or capitalization. Topics can also be similar when the terms are semantically similar.

In step 1340, a set of relevant advertisements is displayed. In one embodiment, the maximum number of advertisements to display is determined. Once the maximum number of advertisements is determined, relevant advertisements equal to the maximum number of advertisements that have the highest relevant advertisement display quotient are displayed. The relevant advertisement quotient is a function of one or more of a relationship between the search constraint of the user and topics associated with relevant advertisements, a relationship between the set of significant topics and topics associated with relevant advertisements, existing click-throughs by a user to relevant advertisements, and premium financial payments by an advertiser to promote display of their advertisement.

In one example, relative advertisements that are displayed are randomly selected from the set of relevant advertisements that were determined in step 1340.

In another example, relevant advertisements that are displayed are relevant advertisements determined in step 1340 in which the advertisers have paid the largest financial premium for placement of their advertisements.

In another example, relevant advertisements that are displayed are relevant advertisements determined in step 1340 in which the topics associated with the advertisement are most similar to the user's constraint terms.

In another example, all relevant advertisements scroll across the screen.

FIG. 14 provides method 1400 for displaying advertisements based on search results from data items within a set of information when a user enters a search constraint, according to an embodiment of the invention. Method 1400 is similar to method 1300, except that search results are ranked by relevancy before a set of significant topics are determined. Using the relevancy factors associated with search results that were discussed above can further improve the relevancy of advertisements that will be displayed along side search results.

Method 1400 begins in step 1410. In step 1410 a search is conducted to generate search results. This step is the same as step 1310 above. In step 1420 the search results are ranked by relevancy. This step was not present in method 1300. Ranking the search results by relevancy includes providing a relevancy rank for each data item in the search results based on one or more of what component of the search result contains the search constraint (e.g., the component was the title of the data item), a proximity of search text (e.g., all search constraints are located near to one another within a data item), and a level of semantics that had to be applied to the search result (e.g., the closer the terms that match the user constraint, the more relevant the search result).

When the search results include Internet websites, the relevancy ranking can also be based on the popularity of the website search result and previous click-throughs by the user to the website search result. Those search results with the highest relevancy ranking are determined to be included in the set of most relevant search results.

In step 1430 a set of significant topics is determined from the most relevant search results. This step is the same as step 1320 above, except that the set of significant topics is determined from the set of most relevant search results in step 1430 and the set of significant topics was determined from all search results in step 1320.

In step 1440 relevant advertisements related to the set of significant topics are identified. In step 1450, the most relevant topics are displayed. Steps 1440 and 1450 are the same as steps 1330 and 1340 respectively. In step 1460, method 1400 ends.

### CONCLUSION

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. A method for displaying advertisements based on search results of data items within a set of information when a user enters a search constraint, comprising:
(a) conducting a search to generate the search results, wherein the search results include a set of data items contained within the set of information;
(b) determining a set of significant topics from the search results;
(c) identifying relevant advertisements that are related to the set of significant topics; and
(d) displaying a set of relevant advertisements.

2. The method of claim 1, wherein each topic comprises a word combination of two or more substantially contiguous words.

3. The method of claim 2, wherein two words are substantially contiguous if they are separated only by zero or more words selected from a predetermined list of words.

4. The method of claim 3, wherein the predetermined list of words comprise STOP words.

5. The method of claim 2, wherein at least one word in each of the word combinations is selected from a predetermined list of words.

6. The method of claim 5, wherein the predetermined list of words comprises a list of domain specific words. information located within a server, information located within a personal computer, information located on the Internet, or information contained within email messages or email attachments.

8. The method of claim 1, wherein data items includes one or more of text documents, graphic documents, audio files, video files, multimedia documents, email messages, email attachments, or Internet web page.

9. The method of claim 1, wherein conducting a search to generate search results comprises:
(i) identifying topics in a data corpus having a plurality of segments that is representative of the set of information, including:
aa. determining a segment-level actual usage value for one or more word combinations;
bb. computing a segment-level expected usage value for each of the one or more word combinations; and
cc. designating a word combination as a topic if the segment-level actual usage value of the word combination is substantially greater than the segment-level expected usage value of the word combination;
(ii) associating topics with each data item included within the set of information; and
(iii) determining that a data item should be included in the search results, when a topic entered by the user matches or is similar to a topic associated with the data item.

10. The method of claim 9, wherein a word combination includes two or more substantially contiguous words.

11. The method of claim 1, wherein determining a set of significant topics from the search results includes:
(i) counting the frequency of occurrence of each topic within the search results;
(ii) hierarchically ranking topics based on the frequency of occurrence of the topic; and
(iii) identifying a topic as among the set of significant topics when its frequency of occurrence ranks above the significant topic threshold, wherein the significant topic threshold is the number of topics to be included in the set of significant topics.

12. The method of claim 1, wherein determining the set of significant topics from the search results includes:
(i) for each topic determining a data item count, wherein the topic data item count is the number of data items within the search results that the topic appears in;
(ii) hierarchically ranking topics based on the data item count of the topic; and
(iii) identifying a topic to be included among the set of significant topics when its data item count ranks above the significant topic threshold, wherein the significant topic threshold is the number of topics to be included in the set of significant topics.

13. The method of claim 1, wherein determining the set of significant topics from the search results includes identifying the most specific topics.

14. The method of claim 13, wherein identifying the most specific topic includes:
(i) determining a preliminary set of most significant topics from the search results;
(ii) for each topic in the preliminary set of most significant topics counting the topic's frequency of occurrence within the set of information;
(ii) identifying as the most specific topics those topics within the preliminary set of most significant topics that have the lowest frequency of occurrence within the set of documents, wherein the topic within the lowest frequency of occurrence within the set of information is given a ranking of 1, the topic with the second lowest frequency of occurrence within the set of information is given a ranking of 2, and so on; and
(iii) identifying a topic as among the most specific topics when its frequency of occurrence ranks above the specific topic threshold, wherein the specific topic threshold is the number of topics to be included in the most specific topics.

15. The method of claim 1, wherein identifying relevant advertisements that are related to the set of significant topic includes selecting an advertisement as relevant when a topic associated with the advertisement matches or is similar to one of the topics within the set of significant topics.

16. The method of claim 1, wherein identifying relevant advertisements that are related to the set of significant topics includes selecting an advertisement as relevant when a topic associated with the advertisement matches the top ranked topic within the set of significant topics.

17. The method of claim 1, wherein identifying relevant advertisements that are related to the set of significant topics includes selecting an advertisement as relevant when a topic associated with the advertisement is similar to a topic within the set of significant topics.

18. The method of claim 1, wherein displaying relevant advertisements includes:
(i) determining the maximum number of advertisements to display;
(ii) displaying relevant advertisements equal to the maximum number of advertisements that have the highest relevant advertisement display quotient, wherein the relevant advertisement quotient is a function of one or more of a relationship between the search constraint of the user and topics associated with relevant advertisements, a relationship between the set of significant topics and topics associated with relevant advertisements, existing click-throughs by a user to relevant advertisements, and premium financial payments by an advertiser to promote display of their advertisement.

19. The method of claim 18, wherein a relevant advertisement has the highest relevant advertisement quotient if a topic associated with the relevant advertisement is the same as the most significant topic.

20. A method for displaying advertisements based on search results from data items within a set of information when a user enters a search constraint, comprising:
(a) conducting a search to generate the search results, wherein the search results include a set of data items contained within the set of information;
(b) ranking the search results by relevancy to determine the most relevant search results;
(c) determining a set of significant topics from the most relevant search results;
(d) identifying relevant advertisements that are related to the set of significant topics; and
(e) displaying the most relevant advertisements.

21. The method of claim 1, wherein each topic comprises a word combination of two or more substantially contiguous words.

22. The method of claim 20, wherein ranking the search results by relevancy includes providing a relevancy rank for each data item in the search results based on one or more of what component of the search result contains the search constraint, a proximity of search text, and a level of semantics that had to be applied to the search result.

23. The method of claim 20, wherein ranking the search results by relevancy when the search results include Internet websites includes providing a relevancy rank for each data item in the search result based on one or more of what component of the search result contains the search constraint, a proximity of search text, a level of semantics that had to be applied to the search result, the popularity of the website search result and previous click-throughs by the user to the website search result.

24. The method of claim 23, wherein determining the set of significant topics from the most relevant search results includes:
(i) counting the frequency of occurrence of each topic within the most relevant search results;
(ii) hierarchically ranking topics based on the frequency of occurrence of the topic; and
(iii) identifying a topic as among the set of significant topics when its frequency of occurrence ranks above the significant topic threshold, wherein the significant topic threshold is the number of topics to be included in the set of significant topics.

25. The method of claim 20, wherein identifying relevant advertisements that are related to the set of significant topic includes selecting an advertisement as relevant when a topic associated with the advertisement is the same as one of the topics within the set of significant topics.

26. The method of claim 20, wherein identifying relevant advertisements that are related to the set of significant topics includes selecting an advertisement as relevant when a topic associated with the advertisement is the same as the top ranked topic within the set of significant topics.

27. The method of claim 20, wherein identifying relevant advertisements that are related to the set of significant topics includes selecting an advertisement as relevant when a topic associated with the advertisement is similar to a topic within the set of significant topics.

28. The method of claim 20, wherein displaying relevant advertisements includes:
(i) determining the maximum number of advertisements to display;
(ii) displaying relevant advertisements equal to the maximum number of advertisements that have the highest relevant advertisement display quotient, wherein the relevant advertisement quotient is a function of one or more of a relationship between the search constraint of the user and topics associated with relevant advertisements, a relationship between the set of significant topics and topics associated with relevant advertisements, existing click-throughs by a user to relevant advertisements, and premium financial payments by an advertiser to promote display of their advertisement.

29. The method of claim 28, wherein a relevant advertisement has the highest relevant advertisement quotient if a topic associated with the relevant advertisement is the same as the most significant topic.
